(19) United States
(12) Patent Application Publication
(10) Pub. No.: US 2003/0186569 A1
(43) Pub. Date: Oct. 2, 2003

(54) . Component mounting structure

(76) Inventors: Yukiko Suzuki, Sapporo (JP); Katsumi Sakuma, Sapporo (JP); Takehiro Seino, Sapporo (JP); Keiji Masuda, Sapporo (JP); Akihiko Sugata, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/278,446

(22) Filed: Oct. 23, 2002

(30) Foreign Application Priority Data
Mar. 29, 2002 (JP) 2002-093633

(51) Int. Cl. H01R 12/00

(52) U.S. Cl. 439/71

(57) ABSTRACT

A component mounting structure including a metal base; a first substrate bonded to the upper surface of the metal base; a first wiring pattern formed on the upper surface of the first substrate; a second substrate horizontally mounted on the upper surface of the first substrate so that the lower surface of the second substrate is in contact with the upper surface of the first substrate; a second wiring pattern formed on the second substrate so as to be connected to the first wiring pattern; and a component mounted on the second substrate so as to be connected to the second wiring pattern.

### BACKGROUND OF THE INVENTION

1. Field of the Invention

The present invention relates to a mounting structure of a substrate on which a component such as a high-frequency component is mounted.

2. Description of the Related Art

With an increase in communication speed, a high-frequency component is used in an amplifying circuit for a transmitter for a wireless device. In the amplifying circuit, a plurality of amplifiers are cascaded to increase the gain. If a DC component is included in an input signal to each amplifier, a problem such as fracture may occur. Accordingly, a capacitor is used to cut off a low-frequency component having frequencies not higher than a given frequency, thereby inputting only a high-frequency signal into each amplifier. The high-frequency component such as a capacitor is mounted on a substrate by soldering or the like, and the input and output of the high-frequency component are connected to wiring patterns formed on the substrate.

FIG. 23 is a diagram showing an equivalent circuit of a transmission line formed by a wiring pattern on a substrate in a high-frequency region. As shown in FIG. 23, the transmission line is equivalent to a circuit composed of a parasitic resistance R, a parasitic inductor L, a parasitic conductance G, and a parasitic capacitance C. The parasitic conductance G and the parasitic capacitance C are formed between the substrate and the ground.

The propagation constant γ of this equivalent circuit is expressed by Eq. (1).

γ=α+jβ=(R+jωL)^{1/2}×(G+jωC) (1)

where α is the attenuation constant, β is the phase constant, and ω is the angular velocity of a signal.

Accordingly, the attenuation depending on frequency is determined by the parasitic inductor L and the parasitic capacitance C. Since the attenuation increases with an increase in frequency, it is necessary to reduce the attenuation of a high-frequency signal. It is understood that the attenuation may be reduced by reducing the parasitic capacitance C. The parasitic capacitance C is formed between a wiring pattern formed on a dielectric substrate and a metal base grounded.

FIGS. 24A and 24B show a component mounting structure in the prior art. FIG. 24A is a perspective view, and FIG. 24B is an elevational view. As shown in FIGS. 24A and 24B, a substrate 2 is bonded to the upper surface of a metal base 1. A pair of wiring patterns 3 are formed on the upper surface of the substrate 2, and a high frequency component 4 such as a capacitor is mounted on the upper surface of the substrate 2 so as to be connected to the wiring patterns 3. The metal base 1 is usually grounded. A parasitic capacitance C is generated between each wiring pattern 3 and the metal base 1.

The parasitic capacitance C is expressed by Eq. (2).

C=εw/h (2)

where ε is the permittivity of the substrate 2, w is the width of each wiring pattern 3, and h is the thickness of the substrate 2.

FIGS. 25A, 25B, and 25C illustrate the parasitic capacitance C in the prior art. FIG. 25A is an elevational view, FIG. 25B is a cross section taken along the line A-A in FIG. 25A, and FIG. 25C is a plan view. As shown in FIGS. 25A to 25C, each wiring pattern 3 has a width w0 of 0.38 mm for providing a characteristic impedance of 50 Ω in a transmission line. However, when the high-frequency component 4 is large in size as shown, the width of the high-frequency component 4 is larger than the width w0, and the width w of a wider portion 3a of each wiring pattern 3 for mounting the high-frequency component 3 is therefore larger than the width w0. For example, in the case that the high-frequency component 4 is a capacitor having a capacitance of 1 μF capable of cutting off a DC component in a 3 KHz band, the width w becomes 0.8 mm, and in the case that the high-frequency component 4 is a capacitor having a capacitance of 0.1 μF capable of cutting off a DC component in a 30 KHz band, the width w becomes about 0.5 mm. Thus, the width w becomes larger than the width w0. As apparent from Eq. (2), the parasitic capacitance C increases with an increase in the wiring pattern width w, resulting in an increase in attenuation increasing with an increase in frequency. In the conventional structure shown in FIGS. 24A and 24B, the metal base 1 is cut at a position just under the high-frequency component 4 to form a vacant portion 5, thereby reducing the permittivity to reduce the parasitic capacitance C.

However, the conventional mounting structure shown in FIGS. 24A and 24B has the following problems. First, the vacant portion 5 is formed by cutting the metal base 1, causing an increase in man-hours and cost. Second, in the case of changing the size of the high-frequency component 4 mounted on the substrate 2 to select desired electrical characteristics of another high-frequency component, it is necessary to also change the substrate 2. That is, it is necessary to form vacant portions having various sizes according to the various sizes of high-frequency components, causing an increase in man-hours. Third, there are variations in electrical characteristics of the high-frequency component 4 and in size of the high-frequency component 4 as a product, it is necessary to adjust the electrical characteristics of the high-frequency component 4 and therefore adjust the size of the vacant portion 5. The size adjustment of the vacant portion 5 is necessarily made by the steps of (i) removing the high-frequency component 4 from the substrate 2, (ii) separating the metal base 1 from the substrate 2, (iii) further cutting the metal base 1 or applying metal to the inner surface of the vacant portion 5, (iv) bonding the metal base 1 to the substrate 2, and (v) remounting the high-frequency component 4 on the substrate 2 by soldering. Thus, the adjustment of the electrical characteristics is troublesome.

### SUMMARY OF THE INVENTION

It is therefore an object of the present invention to provide a component mounting structure which can reduce a parasitic capacitance and can reduce man-hours.

In accordance with an aspect of the present invention, there is provided a component mounting structure including a metal base; a first substrate bonded to the upper surface of said metal base; a first wiring pattern formed on the upper surface of said first substrate; a second substrate horizontally mounted on the upper surface of said first substrate so that the lower surface of said second substrate is in contact with the upper surface of said first substrate; a second wiring pattern formed on said second substrate so as to be connected to said first wiring pattern; and a component mounted on said second substrate so as to be connected to said second wiring pattern.

In accordance with another aspect of the present invention, there is provided a component mounting structure including a metal base; a first substrate bonded to the upper surface of said metal base; a first wiring pattern formed on the upper surface of said first substrate; a second substrate vertically mounted on the upper surface of said first substrate so that one side surface of said second substrate is in contact with the upper surface of said first substrate; a second wiring pattern formed on said second substrate so as to be connected to said first wiring pattern; and a component mounted on said second substrate so as to be connected to said second wiring pattern.

In accordance with a further aspect of the present invention, there is provided a component mounting structure including a metal base; a first substrate bonded to the upper surface of the metal base; a first wiring pattern formed on the upper surface of the first substrate; a second substrate horizontally mounted on the upper surface of the first substrate so that the lower surface of the second substrate is in contact with the upper surface of the first substrate; a second wiring pattern formed on the second substrate so as to be connected to the first wiring pattern; a film formed on the second substrate so as to be connected to the second wiring pattern, the film functioning as an electronic component; a third substrate horizontally mounted on the upper surface of the second substrate so that the lower surface of the third substrate is in contact with the upper surface of the second substrate; a via hole formed through the third substrate; a third wiring pattern formed on the third substrate so as to be connected through the via hole to the second wiring pattern; and a component mounted on the third substrate so as to be connected to the third wiring pattern.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIGS. 1A and 1B are a perspective view and an elevational view, respectively, showing the first principle of the present invention;

FIGS. 2A and 2B are an elevational view and a cross section taken along the line B-B in FIG. 2A, respectively, for illustrating a parasitic capacitance;

FIGS. 3A, 3B, and 3C are a perspective view, an elevational view, and a cross section taken along the line D-D in FIG. 3B, respectively, showing the second principle of the present invention;

FIG. 4 is a perspective view showing a first preferred embodiment of the component mounting structure according to the present invention;

FIG. 5 is a perspective view showing the structure of a main substrate shown in FIG. 4;

FIGS. 6A and 6B are perspective views showing the structure of an auxiliary substrate shown in FIG. 4 as viewed from the upper and lower sides thereof, respectively;

FIG. 7 is a graph for illustrating the effect of the present invention;

FIG. 8 is a perspective view showing a second preferred embodiment of the component mounting structure according to the present invention;

FIG. 9 is a perspective view showing a third preferred embodiment of the component mounting structure according to the present invention;

FIG. 10 is a perspective view showing a fourth preferred embodiment of the component mounting structure according to the present invention;

FIG. 11 is a perspective view showing a fifth preferred embodiment of the component mounting structure according to the present invention;

FIG. 12 is a perspective view showing a sixth preferred embodiment of the component mounting structure according to the present invention;

FIG. 13 is a perspective view showing a seventh preferred embodiment of the component mounting structure according to the present invention;

FIG. 14 is a perspective view showing an eighth preferred embodiment of the component mounting structure according to the present invention;

FIG. 15 is a perspective view showing a ninth preferred embodiment of the component mounting structure according to the present invention;

FIG. 16 is an exploded perspective view showing the structure of auxiliary substrates shown in FIG. 15;

FIG. 17 is a perspective view showing a tenth preferred embodiment of the component mounting structure according to the present invention;

FIG. 18 is an exploded perspective view showing the structure of an auxiliary substrate and an adjusting substrate shown in FIG. 17;

FIG. 19 is a perspective view showing an eleventh preferred embodiment of the component mounting structure according to the present invention;

FIG. 20 is an exploded perspective view showing the structure of auxiliary substrates shown in FIG. 19;

FIG. 21 is a perspective view showing a twelfth preferred embodiment of the component mounting structure according to the present invention;

FIG. 22 is a perspective view showing a thirteenth preferred embodiment of the component mounting structure according to the present invention;

FIG. 23 is a diagram showing an equivalent circuit of a transmission line;

FIGS. 24A and 24B are a perspective view and an elevational view, respectively, showing a component mounting structure in the prior art; and

FIGS. 25A, 25B, and 25C are an elevational view, a cross section taken along the line A-A in FIG. 25A, and a plan view, respectively, for illustrating a parasitic capacitance in the prior art.

### DETAILED DESCRIPTION OF THE PREFERRED EMBODIMENTS

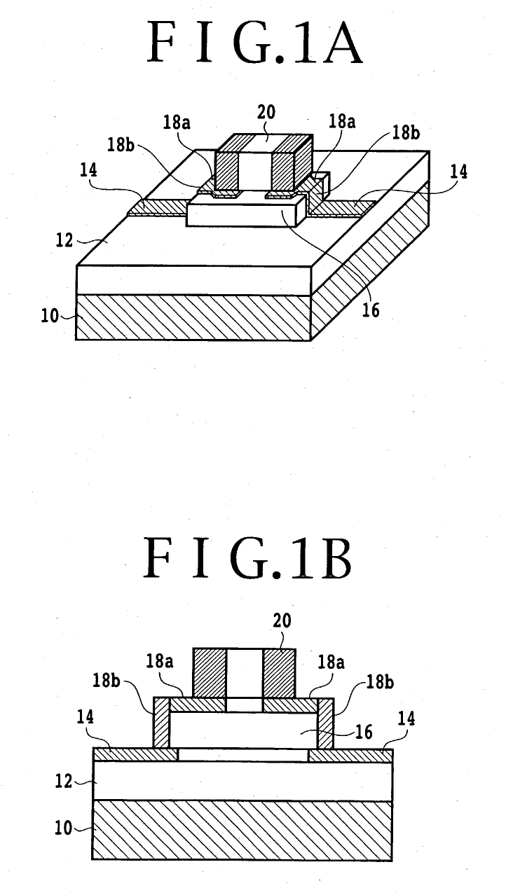

The principles of the present invention will first be described prior to the description of various preferred embodiments of the present invention. FIGS. 1A and 1B are a perspective view and an elevational view, respectively, showing the first principle of the present invention. As shown in FIGS. 1A and 1B, a main substrate 12 is bonded to the upper surface of a metal base 10 by adhesive. A pair of wiring patterns 14 each having a characteristic impedance of 50 Ω are formed on the upper surface of the main substrate 12. An auxiliary substrate 16 is horizontally mounted on the upper surface of the main substrate 12 by soldering or the like in such a manner that the upper surface of the auxiliary substrate 16 is parallel to the upper surface of the main substrate 12. A pair of wiring patterns 18a are formed on the upper surface of the auxiliary substrate 16, and a pair of wiring patterns 18b are formed on the opposite side surfaces of the auxiliary substrate 16 so as to be respectively connected to the pair of wiring patterns 18a. A high-frequency component 20 is mounted on the upper surface of the auxiliary substrate 16 so as to be connected to the wiring patterns 18a. In the case that the size of the high-frequency component 20 is large as shown, each wiring pattern 18a has a wider portion connected to the high-frequency component 20. That is, the width of this wider portion of each wiring pattern 18a is larger than the width of each wiring pattern 14. The wiring patterns 18b formed on the side surfaces of the auxiliary substrate 16 are connected to the wiring patterns 14 formed on the upper surface of the main substrate 12 by soldering or the like.

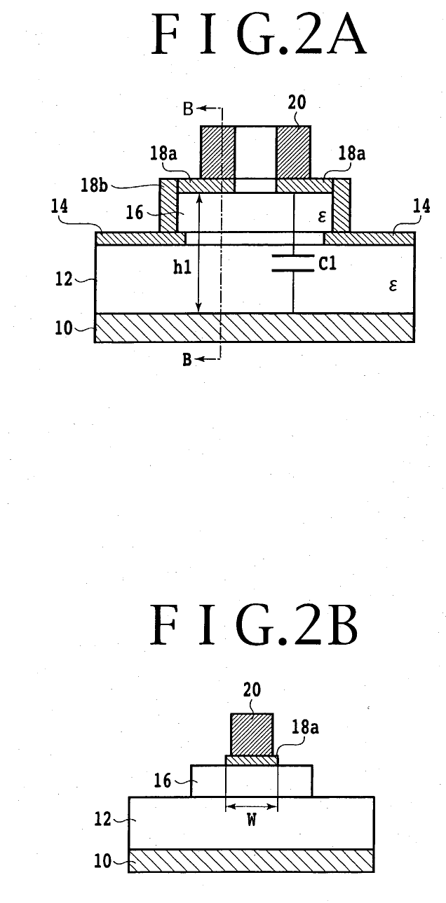

FIGS. 2A and 2B are an elevational view and a cross section taken along the line B-B in FIG. 2A, respectively, for illustrating a parasitic capacitance in the component mounting structure shown in FIGS. 1A and 1B. As shown in FIGS. 2A and 2B, the parasitic capacitance Cl between each wiring pattern 18a on the upper surface of the auxiliary substrate 16 and the metal base 10 is expressed by Eq. (3).

C1=εw/h1 (3)

where ε is the permittivity of each of the main substrate 12 and the auxiliary substrate 16, w is the width of the wider portion of each wiring pattern 18a connected to the high-frequency component 20, and hi is the distance between each wiring pattern 18a on the upper surface of the auxiliary substrate 16 and the metal base 10.

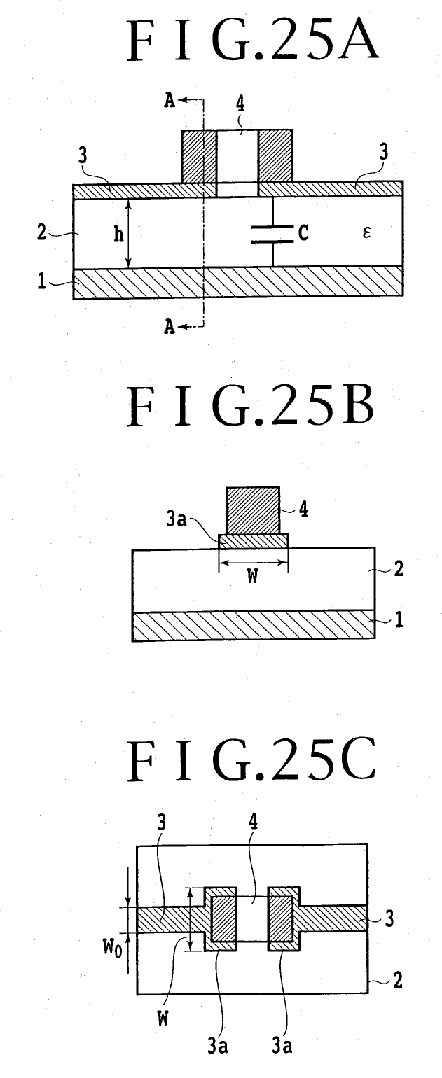

Since h1>h (h is the thickness of the main substrate 12), the parasitic capacitance C1 is reduced as compared with the mounting structure shown in FIGS. 25A to 25C. According to this principle, the high-frequency component 20 is mounted on the auxiliary substrate 16, and the auxiliary substrate 16 is horizontally mounted on the main substrate 12, so that the distance hi between each wiring pattern 18a connected to the high-frequency component 20 and the metal base 10 can be increased to thereby reduce the parasitic capacitance C1.

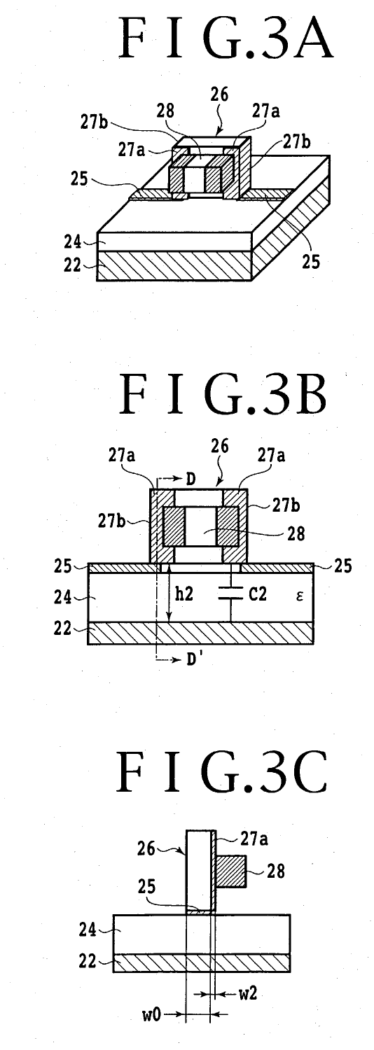

FIGS. 3A, 3B, and 3C are a perspective view, an elevational view, and a cross section taken along the line D-D in FIG. 3B, respectively, showing the second principle of the present invention. As shown in FIGS. 3A to 3C, a main substrate 24 is bonded to a metal base 22. A pair of wiring patterns 25 are formed on the upper surface of the main substrate 24. An auxiliary substrate 26 is vertically mounted on the upper surface of the main substrate 24 in such a manner that the front surface of the auxiliary substrate 26 is perpendicular to the upper surface of the main substrate 24. A pair of wiring patterns 27a are formed on the front surface of the auxiliary substrate 26, and a pair of wiring patterns 27b are formed on the opposite side surfaces of the auxiliary substrate 26 so as to be respectively connected to the pair of wiring patterns 27a. The wiring patterns 27b formed on the side surfaces of the auxiliary substrate 26 are respectively connected to the wiring patterns 25 formed on the upper surface of the main substrate 24. A high-frequency component 28 is mounted on the front surface of the auxiliary substrate 26 so as to be connected to the wiring patterns 27a.

As shown in FIGS. 3B and 3C, the parasitic capacitance C2 between the combination of each wiring pattern 27a and each wiring pattern 27b connected thereto and the metal base 22 is expressed by Eq. (4).

C2=ε(w0+w2)/h2 (4)

where ε is the permittivity of the main substrate 24, w0 is the thickness of the auxiliary substrate 26 (the width of each wiring pattern 27b), w2 is the thickness of each wiring pattern 27a, and h2 is the distance between the auxiliary substrate 26 and the metal base 22.

Since w0+w2 <w (w is the width of each wiring pattern 27a), the parasitic capacitance C2 is reduced as compared with the mounting structure shown in FIGS. 25A to 25C. According to this principle, the high-frequency component 28 is mounted on the auxiliary substrate 26, and the auxiliary substrate 26 is vertically mounted on the main substrate 24, so that the total width (w0+w2) of each wiring pattern 27a and the corresponding wiring pattern 27b opposed to the metal base 22 can be reduced to thereby reduce the parasitic capacitance C2. Furthermore, since the contact area between the main substrate 24 and the wiring patterns 27a and 27b is very small, the parasitic capacitance between the metal base 22 and the wiring patterns 27a and 27b can be further reduced.

First Preferred Embodiment

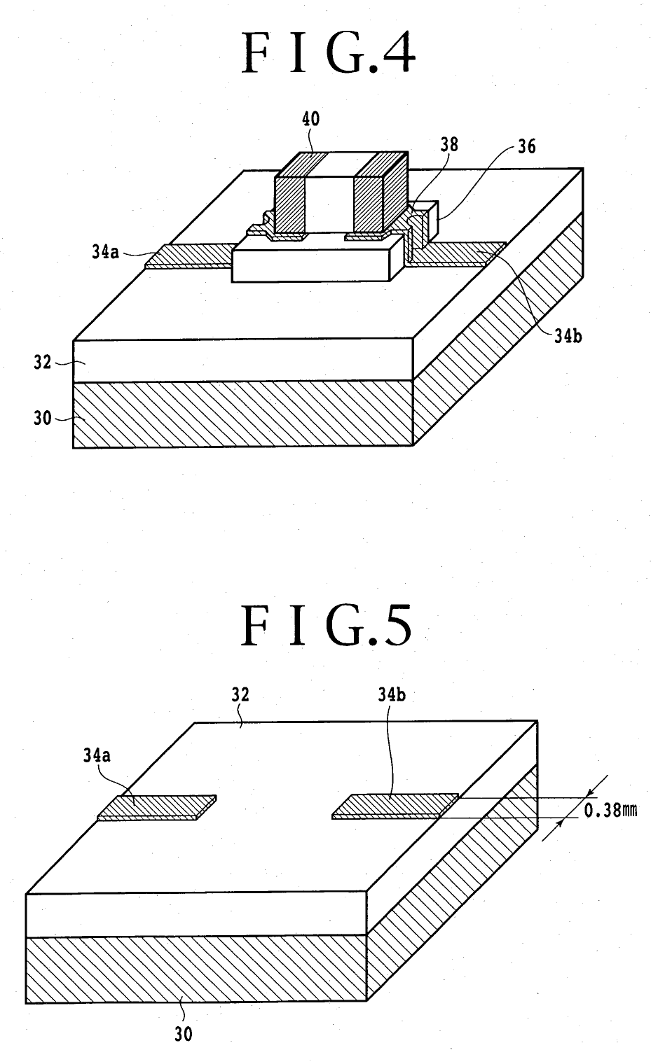

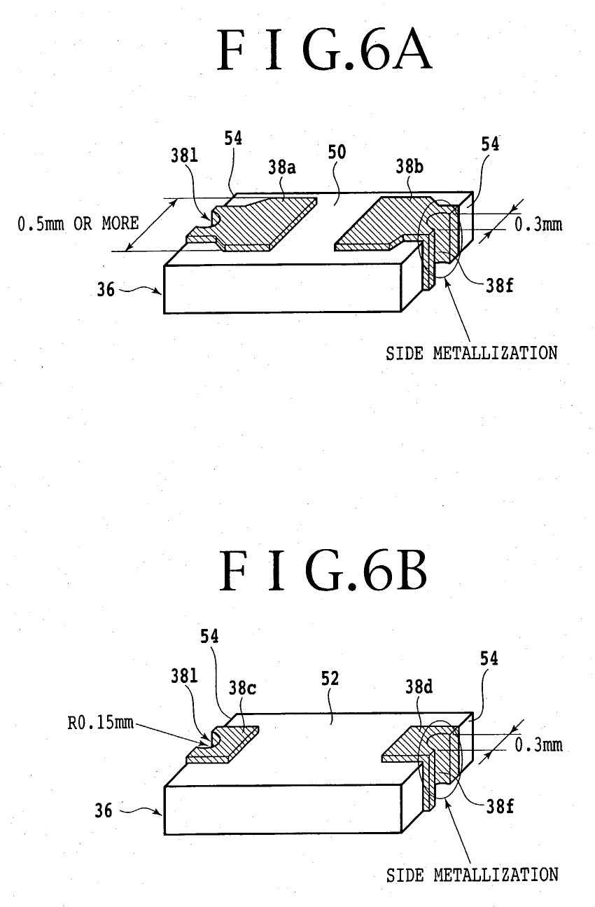

FIG. 4 is a perspective view showing a first preferred embodiment of the component mounting structure according to the present invention, applying the first principle mentioned above. FIG. 5 is a perspective view showing the structure of a main substrate 32 shown in FIG. 4, and FIGS. 6A and 6B are perspective views showing the structure of an auxiliary substrate 36 shown in FIG. 4. More specifically, FIG. 6A is a perspective view showing the structure of the auxiliary substrate 36 as viewed from the upper side thereof, and FIG. 6B is a perspective view showing the structure of the auxiliary substrate 36 as viewed from the lower side thereof. As shown in FIG. 4, the main substrate 32 is bonded to the upper surface of a metal base 30 by conductive adhesive, and the auxiliary substrate 36 is horizontally mounted on the upper surface of the main substrate 32. As shown in FIG. 5, a pair of wiring patterns 34a and 34b are formed on the upper surface of the main substrate 32. Each of the wiring patterns 34a and 34b has a width of 0.38 mm so as to provide a characteristic impedance of 50 Ω. The size of the main substrate 32 is variable according to the kind of a high-frequency component 40 to be mounted. The width of each of the wiring patterns 34a and 34b is fixed irrespective of the kind of the high-frequency component 40.

As shown in FIG. 6A, the auxiliary substrate 36 has an upper surface 50 on which a pair of wiring patterns 38a and 38b are formed to mount the high-frequency component 40. The high-frequency component 40 has a relatively large width, so that each of the wiring patterns 38a and 38b has a wider portion to be connected to the high-frequency component 40. That is, this wider portion has a width (e.g., 0.5 mm or more) larger than the width of a wiring pattern providing a characteristic impedance of 50 Ω. As shown in FIG. 6B, the auxiliary substrate 36 has a lower surface 52 on which a pair of wiring patterns 38c and 38d are formed. The wiring patterns 38c and 38d are respectively connected to the wiring patterns 34a and 34b formed on the main substrate 32. The width of each of the wiring patterns 38c and 38c is equal to the width (0.38 mm) of each of the wiring patterns 34a and 34b. As shown in FIGS. 6A and 6B, the auxiliary substrate 36 has a pair of opposite side surfaces 54 on which a pair of wiring patterns 38e and 38f are formed to respectively connect the wiring patterns 38a and 38b formed on the upper surface 50 to the wiring patterns 38c and 38d formed on the lower surface 52. Each side surface 54 is formed with a semicylindrical recess (radius: 0.15 mm), which is metallized to form each of the wiring patterns 38e and 38f (side metallization). The auxiliary substrate 36 is fabricated by preparing a large substrate having a plurality of pairs of wiring patterns each identical with the pair of wiring patterns 38a and 38b on the upper surface of this substrate and a plurality of pairs of wiring patterns each identical with the pair of wiring patterns 38c and 38d on the lower surface of this substrate, opening a plurality of via holes through the large substrate, metallizing these via holes, and cutting the large substrate at these via holes to thereby obtain a plurality of substrate pieces. In this manner, the auxiliary substrate 36 can be fabricated by a simple process.

As shown in FIG. 4, the high-frequency component 40 is mounted on the upper surface of the auxiliary substrate 36 so as to be connected to the wiring patterns 38a and 38b by soldering or the like. Examples of the high-frequency component 40 include a capacitor, coil, and resistor. In the case that the high-frequency component 40 is a capacitor having a capacitance of 1 μF or less, the width of the high-frequency component is 0.5 mm or more.

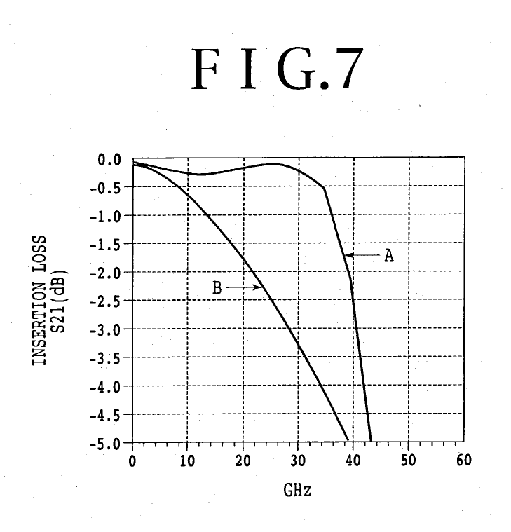

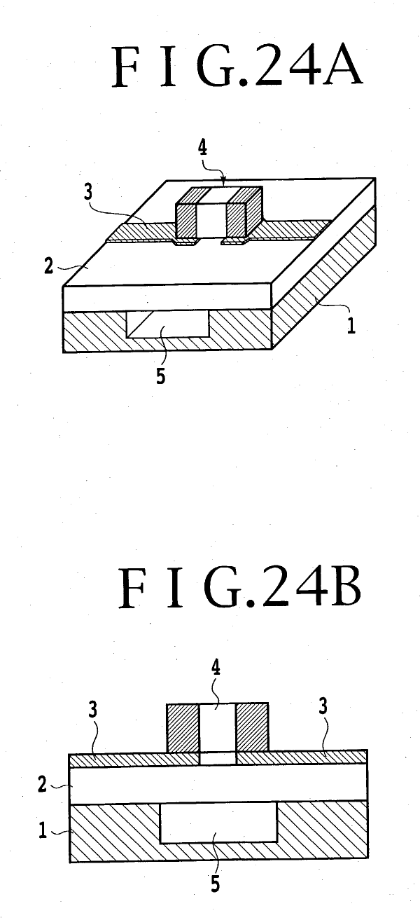

FIG. 7 is a graph for illustrating the effect of the present invention. In FIG. 7, the horizontal axis represents frequency (GHz) and the vertical axis represents insertion loss (S21) (dB). The curve A corresponds to the mounting structure shown in FIG. 4 using a capacitor as the high-frequency component 40, and the curve B corresponds to a conventional structure such that a capacitor is mounted on a substrate as shown in FIGS. 24A and 24B. As apparent from FIG. 7, the present invention shown by the curve A has an effect that the insertion loss can be suppressed in spite of an increase in frequency as compared with the prior art shown by the curve B, owing to the structure that the high-frequency component 40 is mounted on the auxiliary substrate 36 to increase the distance between each of the wiring patterns 38a and 38b and the metal base 30.

In measuring the electrical characteristics of the high-frequency component 40 including insertion loss, there is a case that desired electrical characteristics cannot be obtained because of variations in component size in manufacturing. In this case, the high-frequency component 40 may be separated from the auxiliary substrate 36 and next mounted on another auxiliary substrate. Then, the characteristics of the high-frequency component 40 mounted on the other auxiliary substrate may be measured, thus allowing easy adjustment of the characteristics. Further, in the case of varying the size of the high-frequency component 40, the main substrate 32 and the auxiliary substrate 36 may be replaced by another main substrate and another auxiliary substrate, respectively, so that the size of the high-frequency component 40 can be varied in a simple manner. According to the first preferred embodiment mentioned above, the following effects can be obtained. The substrate (the main substrate 32 and the auxiliary substrate 36) in the high-frequency component mounting structure reduced in parasitic capacitance can be easily fabricated. Further, the size change and characteristics adjustment of the high-frequency component can be made at a reduced cost.

Second Preferred Embodiment

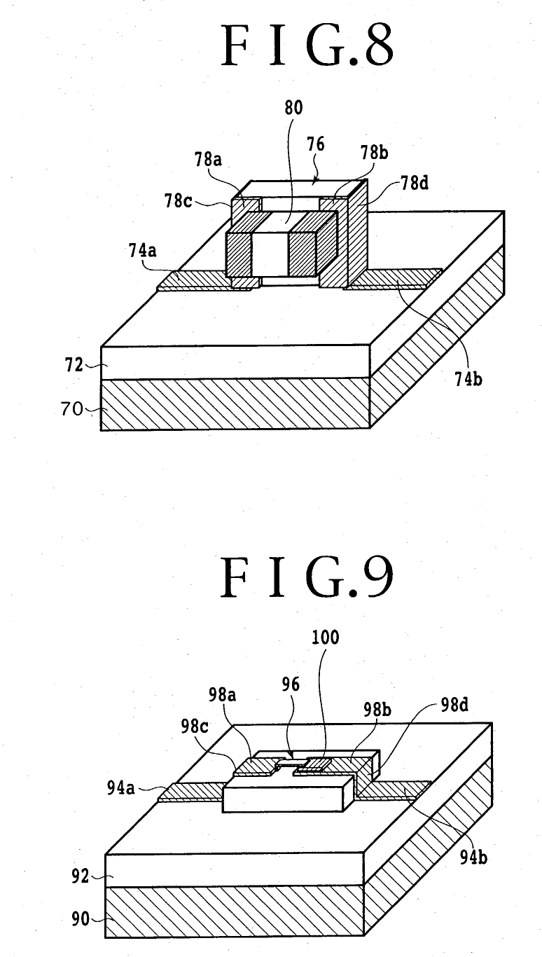

FIG. 8 is a perspective view showing a second preferred embodiment of the component mounting structure according to the present invention, applying the second principle mentioned above. As shown in FIG. 8, a main substrate 72 is bonded to the upper surface of a metal base 70 by conductive adhesive. A pair of wiring patterns 74a and 74b are formed on the upper surface of the main substrate 72. The metal base 70 and the main substrate 72 are substantially the same as the metal base 30 and the main substrate 32 shown in FIG. 4, respectively. Each of the wiring patterns 74a and 74b has a width of 0.38 mm so as to provide a characteristic impedance of 50 Ω.

An auxiliary substrate 76 is vertically mounted on the upper surface of the main substrate 72. The auxiliary substrate 76 has a front surface, a pair of first side surfaces opposed to each other, and a pair of second side surfaces opposed to each other and perpendicular to the first side surfaces. A pair of wiring patterns 78a and 78b are formed on the front surface of the auxiliary substrate 76, and a pair of wiring patterns 78c and 78d are formed on the first side surfaces of the auxiliary substrate 76 so as to be respectively connected to the pair of wiring patterns 78a and 78b. A high-frequency component 80 is mounted on the front surface of the auxiliary substrate 76 so as to be connected to the wiring patterns 78a and 78b. The width of each of the wiring patterns 78a and 78b is larger than the width of each of the wiring patterns 74a and 74b. The wiring patterns 78c and 78d are formed on the whole of the first side surfaces of the auxiliary substrate 76 by side metallization.

The auxiliary substrate 76 is vertically mounted on the upper surface of the main substrate 72 in such a manner that one of the second side surfaces of the auxiliary substrate 76 perpendicular to the first side surfaces on which the wiring patterns 78c and 78d are formed is in contact with the upper surface of the main substrate 72 and that the wiring patterns 78c and 78d are respectively connected to the wiring patterns 74a and 74b formed on the upper surface of the main substrate 72. The width of each of the wiring patterns 78c and 78d is set to 0.38 mm providing a characteristic impedance of 50 Ω, so that the thickness of the auxiliary substrate 76 is 0.38 mm. As apparent from FIG. 8, each of the wiring patterns 78a to 78d formed on the auxiliary substrate 76 is opposed at its lower end to the metal base 70. That is, only the thickness of each of the wiring patterns 78a to 78d is related to the parasitic capacitance between each of the wiring patterns 78a to 78d and the metal base 70. Therefore, the parasitic capacitance can be greatly reduced. The second preferred embodiment mentioned above can exhibit effects similar to those of the first preferred embodiment and an additional effect of further reducing the parasitic capacitance.

Third Preferred Embodiment

FIG. 9 is a perspective view showing a third preferred embodiment of the component mounting structure according to the present invention. As shown in FIG. 9, a main substrate 92 is bonded to the upper surface of a metal base 90 by conductive adhesive, and an auxiliary substrate 96 is horizontally mounted on the upper surface of the main substrate 92. A pair of wiring patterns 94a and 94b are formed on the upper surface of the main substrate 92. A pair of wiring patterns 98a and 98b are formed on the upper surface of the auxiliary substrate 96. A pair of wiring patterns (not shown) are formed on the lower surface of the auxiliary substrate 96. A pair of wiring patterns 98c and 98d are formed on the opposite side surfaces of the auxiliary substrate 96 so as to respectively connect the wiring patterns 98a and 98b formed on the upper surface of the auxiliary substrate 96 to the wiring patterns formed on the lower surface of the auxiliary substrate 96. The wiring patterns formed on the lower surface of the auxiliary substrate 96 are respectively connected to the wiring patterns 94a and 94b formed on the upper surface of the main substrate 92. A SiO₂ film capacitor 100 is formed on the upper surface of the auxiliary substrate 96 so as to be connected to the wiring patterns 98a and 98b. Also in this case that the SiO₂ film capacitor 100 is formed on the auxiliary substrate 96 rather than mounting a high-frequency component, it is possible to obtain effects similar to those of the first preferred embodiment. This preferred embodiment is effective especially in the case that the width of the SiO₂ film capacitor 100 is large due to limitation to the capacitance of the SiO₂ film capacitor 100.

Fourth Preferred Embodiment

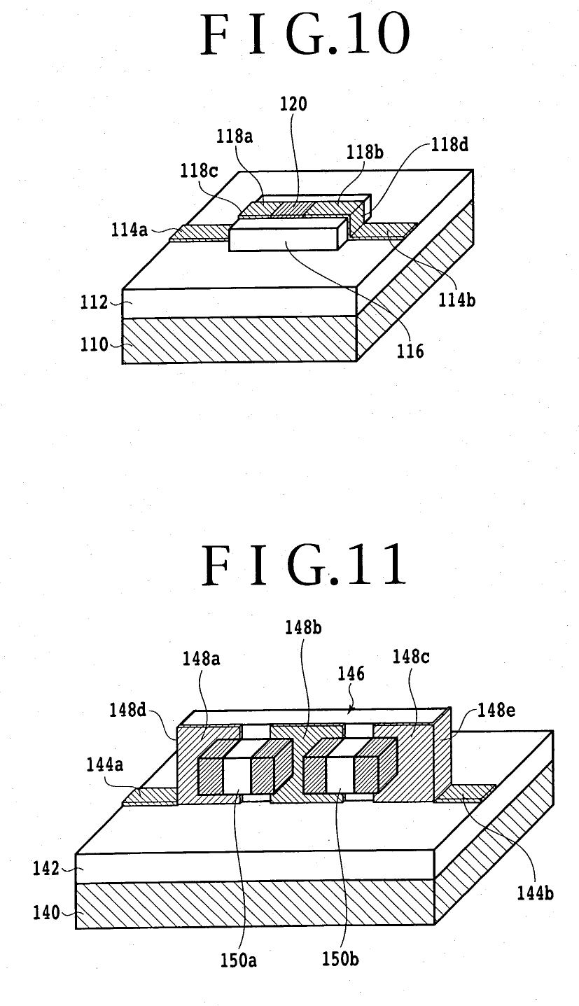

FIG. 10 is a perspective view showing a fourth preferred embodiment of the component mounting structure according to the present invention. As shown in FIG. 10, a main substrate 112 is bonded to the upper surface of a metal base 110 by conductive adhesive, and an auxiliary substrate 116 is horizontally mounted on the upper surface of the main substrate 112. A pair of wiring patterns 114a and 114b are formed on the upper surface of the main substrate 112. A pair of wiring patterns 118a and 118b are formed on the upper surface of the auxiliary substrate 116. A pair of wiring patterns (not shown) are formed on the lower surface of the auxiliary substrate 116. A pair of wiring patterns 118c and 118d are formed on the opposite side surfaces of the auxiliary substrate 116 so as to respectively connect the wiring patterns 118a and 118b formed on the upper surface of the auxiliary substrate 116 to the wiring patterns formed on the lower surface of the auxiliary substrate 116. The wiring patterns formed on the lower surface of the auxiliary substrate 116 are respectively connected to the wiring patterns 114a and 114b formed on the upper surface of the main substrate 112. A film resistor 120 is formed on the upper surface of the auxiliary substrate 116 so as to be connected to the wiring patterns 118a and 118b. Also in this case that the film resistor 120 is formed on the auxiliary substrate 116 rather than mounting a high-frequency component, it is possible to obtain effects similar to those of the first preferred embodiment. This preferred embodiment is effective especially in the case that the width of the film resistor 120 is large due to limitation to the resistance of the film resistor 120.

Fifth Preferred Embodiment

FIG. 11 is a perspective view showing a fifth preferred embodiment of the component mounting structure according to the present invention. The fifth preferred embodiment shown in FIG. 11 corresponds to a modification of the second preferred embodiment wherein two high-frequency components are connected in series. The component mounting structure shown in FIG. 11 includes a metal base 140, a main substrate 142 bonded to the upper surface of the metal base 140, an auxiliary substrate 146 vertically mounted on the upper surface of the main substrate 142, and two high-frequency components 150a and 150b mounted on the front surface of the auxiliary substrate 146. A pair of wiring patterns 144a and 144b are formed on the upper surface of the main substrate 142. A plurality of wiring patterns 148a, 148b, and 148c are formed on the front surface of the auxiliary substrate 146. A pair of wiring patterns 148d and 148e are formed on the first side surfaces of the auxiliary substrate 146 so as to be respectively connected to the wiring patterns 148a and 148c. The two high-frequency components 150a and 150b are connected in series in such a manner that the high-frequency component 150a is connected to the wiring patterns 148a and 148b and the high-frequency component 150b is connected to the wiring patterns 148b and 148c. Each of the high-frequency components 150a and 150b is a capacitor, for example. While the two high-frequency components 150a and 150b are connected in series in this preferred embodiment, more than two high-frequency components may be provided as required. The auxiliary substrate 146 is vertically mounted on the upper surface of the main substrate 142 in such a manner that one of the second side surfaces of the auxiliary substrate 146 perpendicular to the first side surfaces on which the wiring patterns 148d and 148e are formed is in contact with the upper surface of the main substrate 142 and that the wiring patterns 148d and 148e are respectively connected to the wiring patterns 144a and 144b. Also in this case that the high-frequency components 150a and 150b are connected in series, it is possible to obtain effects similar to those of the second preferred embodiment.

Sixth Preferred Embodiment

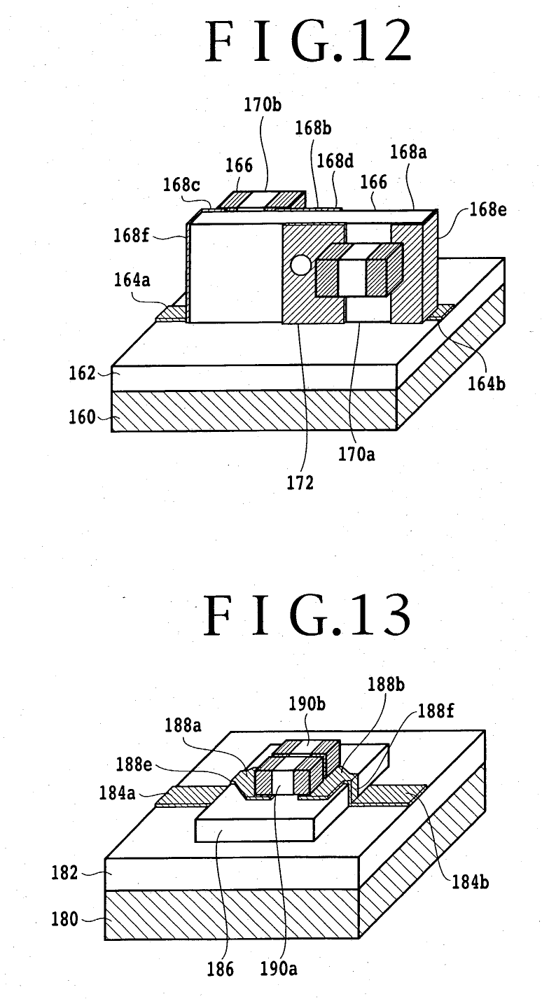

FIG. 12 is a perspective view showing a sixth preferred embodiment of the component mounting structure according to the present invention. Like the fifth preferred embodiment, the sixth preferred embodiment shown in FIG. 12 corresponds to a modification of the second preferred embodiment wherein two high-frequency components are connected in series. The component mounting structure shown in FIG. 12 includes a metal base 160, a main substrate 162 bonded to the upper surface of the metal base 160, an auxiliary substrate 166 vertically mounted on the upper surface of the main substrate 162, and two high-frequency components 170a and 170b respectively mounted on the front surface and the back surface of the auxiliary substrate 166. A pair of wiring patterns 164a and 164b are formed on the upper surface of the main substrate 162. A pair of wiring patterns 168a and 168b are formed on the front surface of the auxiliary substrate 166. A pair of wiring patterns 168c and 168d are formed on the back surface of the auxiliary substrate 166. A pair of wiring patterns 168e and 168f are formed on the first side surfaces of the auxiliary substrate 166 so as to be respectively connected to the wiring patterns 168a and 168c. A via hole 172 is formed through the auxiliary substrate 166 to connect the wiring pattern 168b formed on the front surface of the auxiliary substrate 166 and the wiring pattern 168d formed on the back surface of the auxiliary substrate 166. The two high-frequency components 170a and 170b are connected in series in such a manner that the high-frequency component 170a is connected to the wiring patterns 168a and 168b, that the high-frequency component 170b is connected to the wiring patterns 168c and 168d, and that the wiring pattern 168b is connected through the via hole 172 to the wiring pattern 168d. Each of the high-frequency components 170a and 170b is a capacitor, for example. While the two high-frequency components 170a and 170b are connected in series in this preferred embodiment, more than two high-frequency components may be provided as required. The auxiliary substrate 166 is vertically mounted on the upper surface of the main substrate 162 in such a manner that one of the second side surfaces of the auxiliary substrate 166 perpendicular to the first side surfaces on which the wiring patterns 168e and 168f are formed is in contact with the upper surface of the main substrate 162 and that the wiring patterns 168f and 168e are respectively connected to the wiring patterns 164a and 164b. Also in this case that the high-frequency components 170a and 170b are connected in series, it is possible to obtain effects similar to those of the second preferred embodiment.

Seventh Preferred Embodiment

FIG. 13 is a perspective view showing a seventh preferred embodiment of the component mounting structure according to the present invention. The seventh preferred embodiment shown in FIG. 13 corresponds to a modification of the first preferred embodiment wherein two high-frequency components are connected in parallel. The component mounting structure shown in FIG. 13 includes a metal base 180, a main substrate 182 bonded to the upper surface of the metal base 180, an auxiliary substrate 186 horizontally mounted on the upper surface of the main substrate 182, and two high-frequency components 190a and 190b mounted on the upper surface of the auxiliary substrate 186. A pair of wiring patterns 184a and 184b are formed on the upper surface of the main substrate 182. A pair of wiring patterns 188a and 188b are formed on the upper surface of the auxiliary substrate 186. A pair of wiring patterns (not shown) are formed on the lower surface of the auxiliary substrate 186. A pair of wiring patterns 188e and 188f are formed on the opposite side surfaces of the auxiliary substrate 186 so as to respectively connect the wiring patterns 188a and 188b formed on the upper surface of the auxiliary substrate 186 to the wiring patterns formed on the lower surface of the auxiliary substrate 186. The wiring patterns formed on the lower surface of the auxiliary substrate 186 are respectively connected to the wiring patterns 184a and 184b formed on the upper surface of the main substrate 182. The two high-frequency components 190a and 190b are connected in parallel through the wiring patterns 188a and 188b. Each of the high-frequency components 190a and 190b is a capacitor, for example. While the two high-frequency components 190a and 190b are connected in parallel in this preferred embodiment, more than two high-frequency components may be provided as required. Since the two high-frequency components 190a and 190b are connected in parallel through the wiring patterns 188a and 188b, the width of each of the wiring patterns 188a and 188b is large. In this case, effects similar to those of the first preferred embodiment can be remarkably exhibited.

Eighth Preferred Embodiment

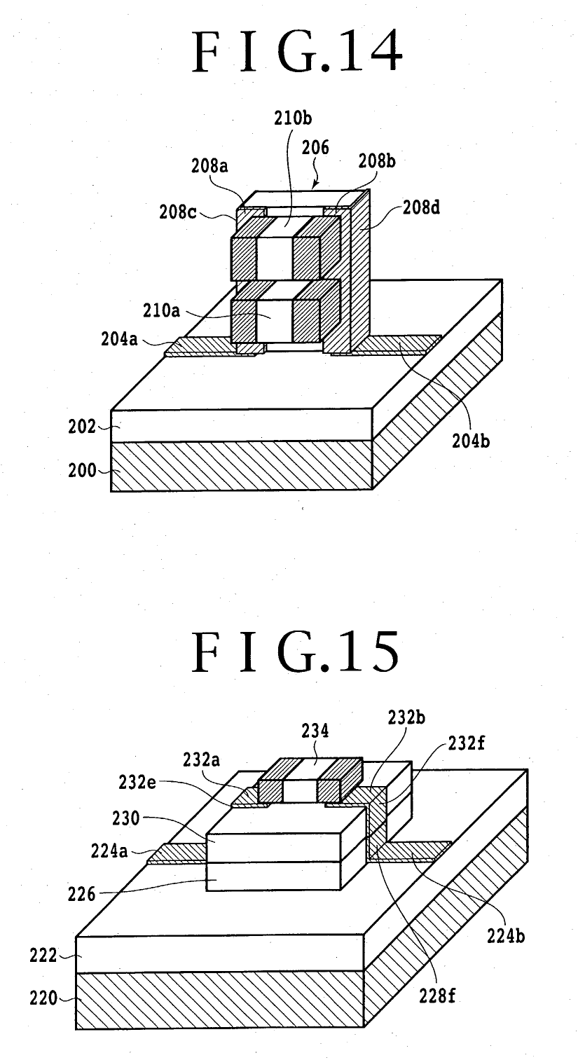

FIG. 14 is a perspective view showing an eighth preferred embodiment of the component mounting structure according to the present invention. This preferred embodiment corresponds to a modification of the second preferred embodiment wherein two high-frequency components are connected in parallel. The component mounting structure shown in FIG. 14 includes a metal base 200, a main substrate 202 bonded to the upper surface of the metal base 200, an auxiliary substrate 206 vertically mounted on the upper surface of the main substrate 202, and two high-frequency components 210a and 210b mounted on the front surface of the auxiliary substrate 206. A pair of wiring patterns 204a and 204b are formed on the upper surface of the main substrate 202. A pair of wiring patterns 208a and 208b are formed on the front surface of the auxiliary substrate 206. A pair of wiring patterns 208c and 208d are formed on the first side surfaces of the auxiliary substrate 206 so as to be respectively connected to the wiring patterns 208a and 208b. The two high-frequency components 210a and 210b are connected in parallel through the wiring patterns 208a and 208b. Each of the high-frequency components 210a and 210b is a capacitor, for example. While the two high-frequency components 210a and 210b are connected in parallel in this preferred embodiment, more than two high-frequency components may be provided as required. The auxiliary substrate 206 is vertically mounted on the upper surface of the main substrate 202 in such a manner that one of the second side surfaces of the auxiliary substrate 206 perpendicular to the first side surfaces on which the wiring patterns 208c and 208d are formed is in contact with the upper surface of the main substrate 202 and that the wiring patterns 208c and 208d are respectively connected to the wiring patterns 204a and 204b. Since the two high-frequency components 210a and 210b are connected in parallel through the wiring patterns 208a and 208b, the width of each of the wiring patterns 208a and 208b is large. In this case, effects similar to those of the second preferred embodiment can be remarkably exhibited.

Ninth Preferred Embodiment

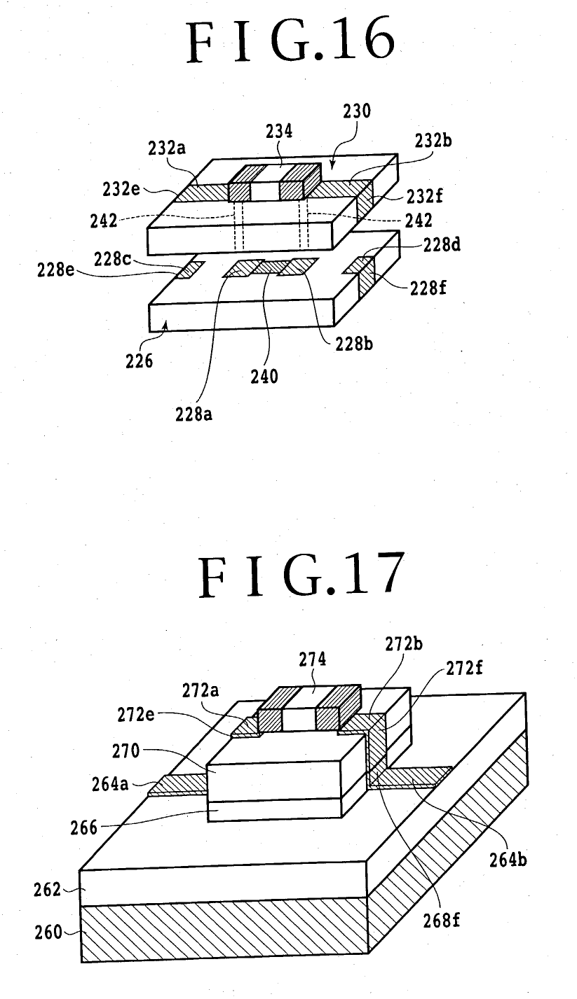

FIG. 15 is a perspective view showing a ninth preferred embodiment of the component mounting structure according to the present invention. This preferred embodiment corresponds to a modification of the first preferred embodiment wherein two auxiliary substrates are layered. The component mounting structure shown in FIG. 15 includes a metal base 220, a main substrate 222 bonded to the upper surface of the metal base 220, a first auxiliary substrate 226 horizontally mounted on the upper surface of the main substrate 222, a second auxiliary substrate 230 horizontally mounted on the upper surface of the first auxiliary substrate 226, and a high-frequency component 234 mounted on the upper surface of the second auxiliary substrate 230. FIG. 16 is an exploded perspective view of the first and second auxiliary substrates 226 and 230. As shown in FIGS. 15 and 16, a pair of wiring patterns 224a and 224b are formed on the upper surface of the main substrate 222. A plurality of wiring patterns 228a, 228b, 228c, and 228d are formed on the upper surface of the first auxiliary substrate 226. A pair of wiring patterns (not shown) are formed on the lower surface of the first auxiliary substrate 226. A pair of wiring patterns 228e and 228f are formed on the opposite side surfaces of the first auxiliary substrate 226 so as to respectively connect the wiring patterns 228c and 228d to the wiring patterns formed on the lower surface of the first auxiliary substrate 226. The wiring patterns formed on the lower surface of the first auxiliary substrate 226 are respectively connected to the wiring patterns 224a and 224b formed on the upper surface of the main substrate 222.

A film resistor 240 is formed on the upper surface of the first auxiliary substrate 226 so as to be connected to the wiring patterns 228a and 228b. The film resistor 240 may be replaced by a SiO₂ film capacitor, for example. A pair of wiring patterns 232a and 232b are formed on the upper surface of the second auxiliary substrate 230. A pair of wiring patterns (not shown) are formed on the lower surface of the second auxiliary substrate 230. A pair of wiring patterns 232e and 232f are formed on the opposite side surfaces of the second auxiliary substrate 230 so as to respectively connect the wiring patterns 232a and 232b to the wiring patterns formed on the lower surface of the second auxiliary substrate 230. The high-frequency component 234 is connected to the wiring patterns 232a and 232b formed on the upper surface of the second auxiliary substrate 230. The wiring patterns formed on the lower surface of the second auxiliary substrate 230 are respectively connected to the wiring patterns 228c and 228d formed on the upper surface of the first auxiliary substrate 226. A pair of via holes 242 are formed through the second auxiliary substrate 230 so as to connect the wiring pattern 232a to the wiring pattern 228a and connect the wiring pattern 232b to the wiring pattern 228b. Accordingly, the high-frequency component 234 is connected in parallel to the film resistor 240 through the wiring patterns 232a and 232b, the via holes 242, and the wiring patterns 228a and 228b. Also in this case where the film resistor 240 and the high-frequency component 234 are connected in parallel, effects similar to those of the first preferred embodiment can be obtained.

Tenth Preferred Embodiment

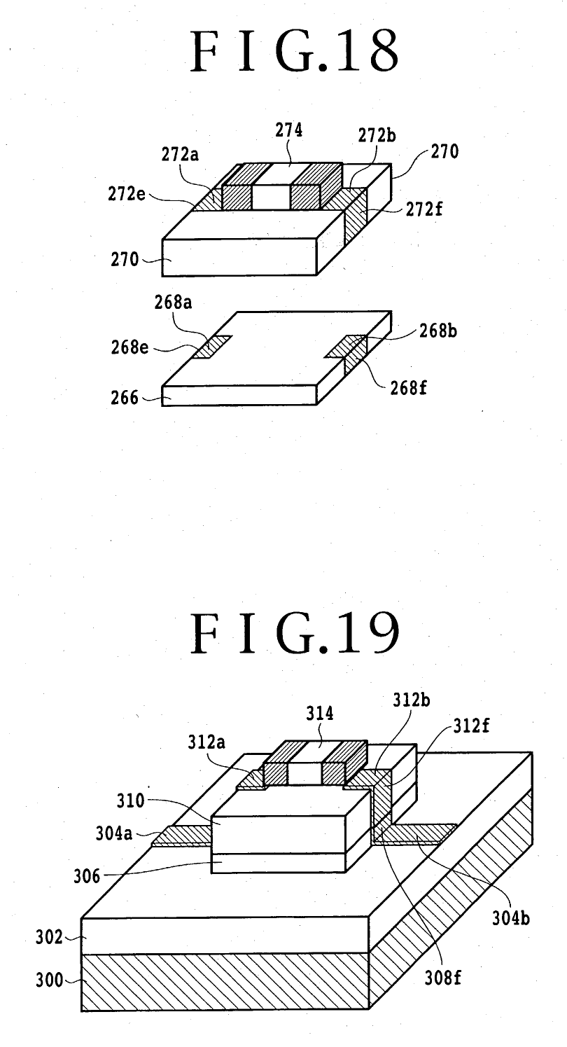

FIG. 17 is a perspective view showing a tenth preferred embodiment of the component mounting structure according to the present invention. This preferred embodiment corresponds to a modification of the first preferred embodiment wherein an adjusting substrate is added. The component mounting structure shown in FIG. 17 includes a metal base 260, a main substrate 262 bonded to the upper surface of the metal base 260, an adjusting substrate 266 horizontally mounted on the upper surface of the main substrate 262, an auxiliary substrate 270 horizontally mounted on the upper surface of the adjusting substrate 266, and a high-frequency component 274 mounted on the upper surface of the auxiliary substrate 270. FIG. 18 is an exploded perspective view of the adjusting substrate 266 and the auxiliary substrate 270 shown in FIG. 17. As shown in FIGS. 17 and 18, a pair of wiring patterns 264a and 264b are formed on the upper surface of the main substrate 262. A pair of wiring patterns 268a and 268b are formed on the upper surface of the adjusting substrate 266. A pair of wiring patterns (not shown) are formed on the lower surface of the adjusting substrate 266. A pair of wiring patterns 268e and 268f are formed on the opposite side surfaces of the adjusting substrate 266 so as to respectively connect the wiring patterns 268a and 268b to the wiring patterns formed on the lower surface of the adjusting substrate 266. The adjusting substrate 266 is used for adjustment of the electrical characteristics of the high-frequency component 274 to desired characteristics in the condition where it is mounted on the auxiliary substrate 270. The adjusting substrate 266 is a suitable one selected from a plurality of adjusting substrates different in thickness prepared for various kinds of high-frequency components, e.g., different available capacitances of capacitors. The use of the adjusting substrate 266 is intended to eliminate the need for separating the high-frequency component 274 from the auxiliary substrate 270 and next remounting the high-frequency component 274 on another auxiliary substrate for the purpose of adjustment of the characteristics. That is, the characteristics can be adjusted by separating the adjusting substrate 266 and using another adjusting substrate instead.

A pair of wiring patterns 272a and 272b are formed on the upper surface of the auxiliary substrate 270. A pair of wiring patterns (not shown) are formed on the lower surface of the auxiliary substrate 270. A pair of wiring patterns 272e and 272f are formed on the opposite side surfaces of the auxiliary substrate 270 so as to respectively connect the wiring patterns 272a and 272b to the wiring patterns formed on the lower surface of the auxiliary substrate 270. The high-frequency component 274 is connected to the wiring patterns 272a and 272b formed on the upper surface of the auxiliary substrate 270. The wiring patterns formed on the lower surface of the auxiliary substrate 270 are respectively connected to the wiring patterns 268a and 268b formed on the upper surface of the adjusting substrate 266. The wiring patterns formed on the lower surface of the adjusting substrate 266 are respectively connected to the wiring patterns 264a and 264b formed on the upper surface of the main substrate 262. When the adjustment of the electrical characteristics of the high-frequency component 274 is required in measuring the characteristics, it is only necessary to replace the adjusting substrate 266 with another adjusting substrate, thereby facilitating the adjustment. Thus, this preferred embodiment can exhibit an effect of facilitating the adjustment in addition to effects similar to those of the first preferred embodiment.

Eleventh Preferred Embodiment

FIG. 19 is a perspective view showing an eleventh preferred embodiment of the component mounting structure according to the present invention. This preferred embodiment corresponds to a modification of the tenth preferred embodiment wherein the adjusting substrate is cut out at its central portion. FIG. 20 is an exploded perspective view of an adjusting substrate 306 and an auxiliary substrate 310 shown in FIG. 19. As shown in FIG. 20, the adjusting substrate 306 is cut out at a central portion 320 thereof. A pair of wiring patterns 312a and 312b formed on the upper surface of the auxiliary substrate 310 are located above the central portion 320 of the adjusting substrate 306. That is, the central portion 320 of the adjusting substrate 306 below the wiring patterns 312a and 312b is vacant, so that the parasitic capacitance can be further reduced. Thus, this preferred embodiment can exhibit an effect of further reducing the parasitic capacitance in addition to the effects of the tenth preferred embodiment.

Twelfth Preferred Embodiment

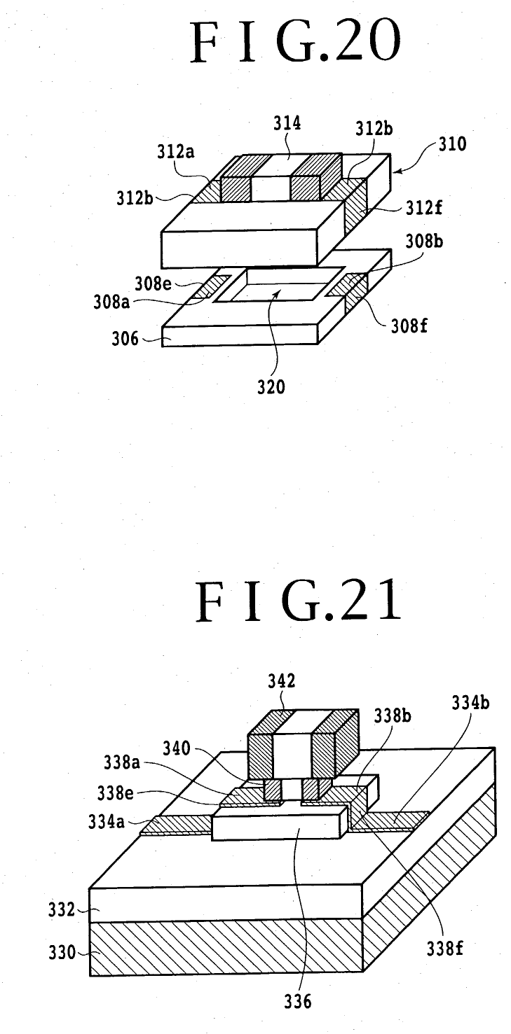

FIG. 21 is a perspective view showing a twelfth preferred embodiment of the component mounting structure according to the present invention. This preferred embodiment corresponds to a modification of the first preferred embodiment wherein a plurality of high-frequency components stacked are mounted on the auxiliary substrate. The component mounting structure shown in FIG. 21 includes a metal base 330, a main substrate 332 bonded to the upper surface of the metal base 330, an auxiliary substrate 336 horizontally mounted on the upper surface of the main substrate 332, and a stack of two high-frequency components 340 and 342 mounted on the upper surface of the auxiliary substrate 336. A pair of wiring patterns 334a and 334b are formed on the upper surface of the main substrate 332. A pair of wiring patterns 338a and 338b are formed on the upper surface of the auxiliary substrate 336. A pair of wiring patterns (not shown) are formed on the lower surface of the auxiliary substrate 336. A pair of wiring patterns 338e and 338f are formed on the opposite side surfaces of the auxiliary substrate 336 so as to respectively connect the wiring patterns 338a and 338b to the wiring patterns formed on the lower surface of the auxiliary substrate 336. The wiring patterns formed on the lower surface of the auxiliary substrate 336 are respectively connected to the wiring patterns 334a and 334b formed on the upper surface of the main substrate 332. The two high-frequency components 340 and 342 are integrally connected in parallel to the wiring patterns 338a and 338b in the condition where the components 340 and 342 are stacked. More than two high-frequency components may be similarly connected. In this preferred embodiment, the high-frequency components 340 and 342 are capacitors having different sizes, and the high-frequency component 340 smaller in size than the high-frequency component 342 is connected to the wiring patterns 338a and 338b. The reason for this arrangement is that if the high-frequency component 342 larger in size than the high-frequency component 340 is connected to the wiring patterns 338a and 338b, the wiring patterns 338a and 338b become long to cause an increase in parasitic inductor. Also in this case that the high-frequency components 340 and 342 stacked and connected in parallel are mounted on the auxiliary substrate 336, it is possible to obtain effects similar to those of the first preferred embodiment.

Thirteenth Preferred Embodiment

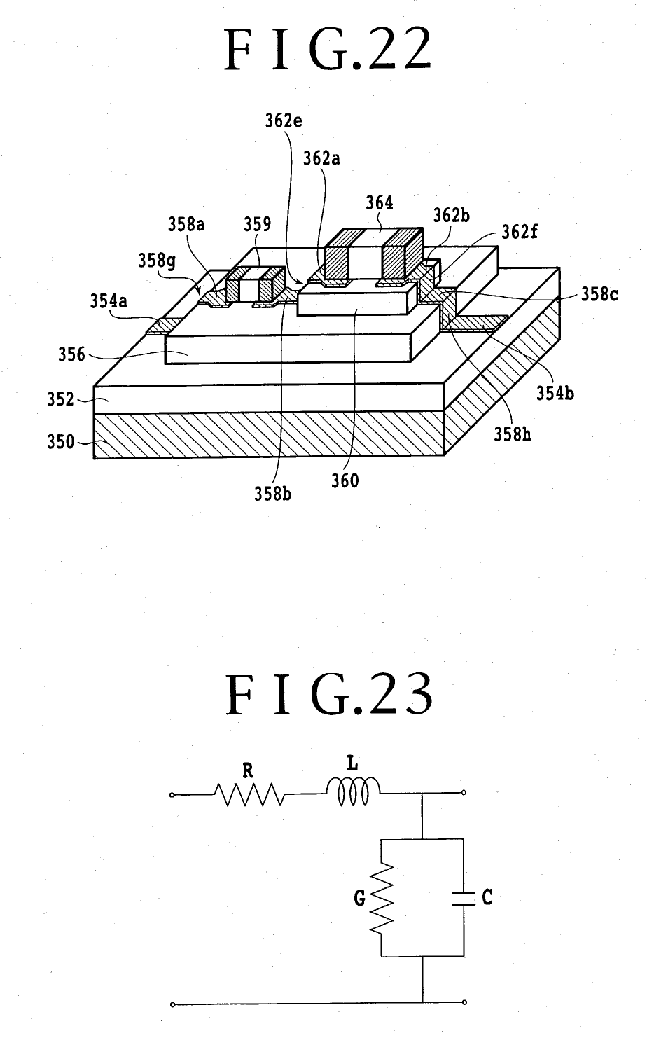

FIG. 22 is a perspective view showing a thirteenth preferred embodiment of the component mounting structure according to the present invention. This preferred embodiment corresponds to a modification of the first preferred embodiment wherein another auxiliary substrate is mounted on the original auxiliary substrate and two high-frequency components are connected in series. The component mounting structure shown in FIG. 22 includes a metal base 350, a main substrate 352 bonded to the upper surface of the metal base 350, a first auxiliary substrate 356 horizontally mounted on the upper surface of the main substrate 352, a second auxiliary substrate 360 horizontally mounted on the upper surface of the first auxiliary substrate 356, a first high-frequency component 359 mounted on the upper surface of the first auxiliary substrate 356, and a second high-frequency component 364 mounted on the upper surface of the second auxiliary substrate 360. A pair of wiring patterns 354a and 354b are formed on the upper surface of the main substrate 352. A plurality of wiring patterns 358a, 358b, and 358c are formed on the upper surface of the first auxiliary substrate 356. A pair of wiring patterns (not shown) are formed on the lower surface of the first auxiliary substrate 356. A pair of wiring patterns 358g and 358h are formed on the opposite side surfaces of the first auxiliary substrate 356 so as to respectively connect the wiring patterns 358a and 358c to the wiring patterns formed on the lower surface of the first auxiliary substrate 356. The wiring patterns formed on the lower surface of the first auxiliary substrate 356 are respectively connected to the wiring patterns 354a and 354b formed on the upper surface of the main substrate 352. The first high-frequency component 359f is connected to the wiring patterns 358a and 358b formed on the upper surface of the first auxiliary substrate 356. A pair of wiring patterns 362a and 362b are formed on the upper surface of the second auxiliary substrate 360. A pair of wiring patterns (not shown) are formed on the lower surface of the second auxiliary substrate 360. A pair of wiring patterns 362e and 362f are formed on the opposite side surfaces of the second auxiliary substrate 360 so as to respectively connect the wiring patterns 362a and 362b to the wiring patterns formed on the lower surface of the second auxiliary substrate 360. The wiring patterns formed on the lower surface of the second auxiliary substrate 360 are respectively connected to the wiring patterns 358b and 358c formed on the upper surface of the first auxiliary substrate 356.

The second high-frequency component 364 is connected to the wiring patterns 362a and 362b formed on the upper surface of the second auxiliary substrate 360. The first and second high-frequency components 359 and 364 are connected in series through the wiring pattern 358b, the wiring pattern formed on the lower surface of the second auxiliary substrate 360 and connected to the wiring pattern 358b, the wiring pattern 362e, and the wiring pattern 362a. Each of the high-frequency components 359 and 364 is a capacitor, for example, and the high-frequency component 359 is smaller in size than the high-frequency component 364. According to this preferred embodiment, the second auxiliary substrate 360 is horizontally mounted on the first auxiliary substrate 356, and the high-frequency component 364 is mounted on the second auxiliary substrate 360. Accordingly, the distance between the metal base 350 and each of the wiring patterns 362a and 362b connected to the high-frequency component 364 can be further increased to thereby further reduce the parasitic capacitance as compared with the first preferred embodiment. Furthermore, it is not necessary to cut the upper surface of the metal base at a position under the high-frequency component as in the conventional structure shown in FIGS. 24A and 24B. Accordingly, the component mounting structure can be fabricated at a low cost.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A component mounting structure comprising:
a metal base;
a first substrate bonded to the upper surface of said metal base;
a first wiring pattern formed on the upper surface of said first substrate;
a second substrate horizontally mounted on the upper surface of said first substrate so that the lower surface of said second substrate is in contact with the upper surface of said first substrate;
a second wiring pattern formed on said second substrate so as to be connected to said first wiring pattern; and
a component mounted on said second substrate so as to be connected to said second wiring pattern.

2. A component mounting structure comprising:
a metal base;
a first substrate bonded to the upper surface of said metal base;
a first wiring pattern formed on the upper surface of said first substrate;
a second substrate vertically mounted on the upper surface of said first substrate so that one side surface of said second substrate is in contact with the upper surface of said first substrate;
a second wiring pattern formed on said second substrate so as to be connected to said first wiring pattern; and
a component mounted on said second substrate so as to be connected to said second wiring pattern.

3. A component mounting structure comprising:
a metal base;
a first substrate bonded to the upper surface of said metal base;
a first wiring pattern formed on the upper surface of said first substrate;
a second substrate horizontally mounted on the upper surface of said first substrate so that the lower surface of said second substrate is in contact with the upper surface of said first substrate;
a second wiring pattern formed on said second substrate so as to be connected to said first wiring pattern;
a film formed on said second substrate so as to be connected to said second wiring pattern, said film functioning as an electronic component;
a third substrate horizontally mounted on the upper surface of said second substrate so that the lower surface of said third substrate is in contact with the upper surface of said second substrate;
a via hole formed through said third substrate;
a third wiring pattern formed on said third substrate so as to be connected through said via hole to said second wiring pattern; and
a component mounted on said third substrate so as to be connected to said third wiring pattern.

4. A component mounting structure comprising:
a metal base;
a first substrate bonded to the upper surface of said metal base;
a first wiring pattern formed on the upper surface of said first substrate;
a second substrate horizontally mounted on the upper surface of said first substrate so that the lower surface of said second substrate is in contact with the upper surface of said first substrate;
a second wiring pattern formed on said second substrate so as to be connected to said first wiring pattern;
a third substrate horizontally mounted on the upper surface of said second substrate so that the lower surface of said third substrate is in contact with the upper surface of said second substrate;
a third wiring pattern formed on said third substrate so as to be connected to said second wiring pattern; and
a component mounted on said third substrate so as to be connected to said third wiring pattern.

5. A component mounting structure according to claim 1, wherein said second wiring pattern comprises a wiring pattern formed on the upper surface of said second substrate, a wiring pattern formed on the lower surface of said second substrate, and a wiring pattern formed on one side surface of said second substrate so as to connect said wiring patterns formed on the upper and lower surfaces of said second substrate;
said wiring pattern formed on the lower surface of said second substrate being connected to said first wiring pattern formed on said first substrate;
said one side surface of said second substrate being formed with a semicylindrical recess;
said wiring pattern formed on said one side surface of said second substrate being a metallic film.

6. A component mounting structure according to claim 1, wherein said second wiring pattern has a wider portion to which said component is connected, said wider portion of said second wiring pattern having a width larger than that of said first wiring pattern.

7. A component mounting structure according to claim 1, wherein said component comprises a plurality of components connected in series through said second wiring pattern.

8. A component mounting structure according to claim 2, wherein said second substrate is formed with a via hole; and
said second wiring pattern comprises a wiring pattern formed on the front surface of said second substrate and a wiring pattern formed on the back surface of said second substrate;
said wiring pattern formed on the front surface of said second substrate being connected through said via hole to said wiring pattern formed on the back surface of said second substrate;
said component comprising a component mounted on the front surface of said second substrate so as to be connected to said wiring pattern formed on the front surface of said second substrate and a component mounted on the back surface of said second substrate so as to be connected to said wiring pattern formed on the back surface of said second substrate.

9. A component mounting structure according to claim 1, wherein said component comprises a plurality of components connected in parallel through said second wiring pattern.

10. A component mounting structure according to claim 2, wherein said component comprises a plurality of components connected in parallel through said second wiring pattern.

11. A component mounting structure according to claim 4, wherein said second substrate is formed with a vacant portion at a position under said third wiring pattern.

12. A component mounting structure according to claim 1, wherein said component comprises a plurality of components integrally connected in parallel.

13. A component mounting structure according to claim 1, further comprising:
a third substrate horizontally mounted on the upper surface of said second substrate so that the lower surface of said third substrate is in contact with the upper surface of said second substrate;
a third wiring pattern formed on said third substrate so as to be connected to said second wiring pattern; and
a second component mounted on said third substrate so as to be connected to said third wiring pattern.
